(19) United States
(12) Patent Application Publication
(10) Pub. No.: US 2021/0017094 A1
(43) Pub. Date: Jan. 21, 2021

(54) COMPOSITE FERTILIZER CONTAINING MAGNESIUM AMMONIUM PHOSPHATE AND POLYGLUTAMIC ACID

(71) Applicant: JIANGSU HUIFENG BIO AGRICULTURE CO., LTD., Yancheng, Jiangsu (CN)

(72) Inventors: Hangen ZHONG, Yancheng (CN); Hongjin JI, Yancheng (CN); Ming ZHANG, Yancheng (CN); Lijuan LUO, Yancheng (CN); Ying WANG, Yancheng (CN); Ying WANG, Yancheng (CN); Jianfeng WEI, Yancheng (CN)

(73) Assignee: JIANGSU HUIFENG BIO AGRICULTURE CO., LTD., Yancheng, Jiangsu (CN)

(21) Appl. No.: 16/969,606

(22) PCT Filed: Feb. 2, 2019
(86) PCT No.: PCT/CN2019/074613

§ 371 Date: Aug. 13, 2020

(30) Foreign Application Priority Data
Feb. 13, 2018 (CN) 201810147637.1

(51) Int. Cl. C05B 9/00; C05F 11/00; C05G 1/00; C05G 5/12; C05G 3/00

(52) U.S. Cl. CPC C05B 9/00; C05F 11/00; C05G 3/00; C05G 5/12; C05G 1/00

(57) ABSTRACT

A composite fertilizer containing magnesium ammonium phosphate and polyglutamic acid. A weight ratio of the polyglutamic acid to the magnesium ammonium phosphate is 1:100 to 10000, preferably 1:200 to 8000. An experimental result indicates that the composite fertilizer can well regulate the growth of crops, improve the disease resistance and stress tolerance, promote the healthy effect of the crops, and increase the yield of the crops.

### BACKGROUND

### Technical Field

The present invention belongs to the technical field of agricultural fertilizers, and relates to a functional composite fertilizer, and in particular to a composite fertilizer containing magnesium ammonium phosphate and polyglutamic acid.

### Related Art

Magnesium ammonium phosphate, also known as struvite for its earliest discovery in bird manure, is a white inorganic crystalline mineral, orthorhombic system, with crystals usually in the form of axes, wedges, short columns or thick plates. The relative density is 1.71, the relative molecular mass is 245.43, the solubility in cold water is rather low, it is easy to dissolve in hot water and dilute acid, it is insoluble in ethanol, and it decomposes in alkali solution. The magnesium ammonium phosphate is small in solubility, does not damage the root system of crops, and can meet the nutrient requirements of the crops in different periods, promote the growth of the crops, enhance the disease resistance of the crops, improve the yield and quality of melons, fruits, vegetables, flowers and the like, enable the fruits of the crops to be bright in color, mellow in taste, rich in nutrition and reduce environmental pollution. Researches made by many scholars have indicated that magnesium ammonium phosphate is an excellent slow-release fertilizer and has good effect in agricultural application.

γ-poly-glutamic acid (short for γ-PGA), also known as natto gum and polyglutamic acid, is a kind of water-soluble, biodegradable, non-toxic biopolymer prepared by microbial fermentation. Polyglutamic acid is a kind of homopolymerized amino acid formed by polymerizing glutamic acid monomers through amido bonds, has the advantages of excellent biodegradability, super adsorption, no toxicity and the like, and has multiple effects of reducing the loss of fertilizer nutrients, improving the utilization rate of the fertilizer, regulating the growth of plants and the like when being added into a composite fertilizer. The polyglutamic acid has obvious application effects on plants such as rice, wheat, corn, vegetables, fruit trees, flowers and the like, and can obviously improve crop yield.

At present, in the process of agricultural crop planting, due to long-term unreasonable use of fertilizers and pesticides, such as chemical application of elementary substances such as high nitrogen and high phosphorus to regulate crop growth and improve crop yield, and long-term application of chemical phosphorus-containing pesticides, the concentration of single nutrients in soil is too high, which not only cause excessive stock of phase reaction in the soil, but also produce harmful substances in the soil, and become a main factor that causing soil hardening in some areas, resulting in decline of crop yield, reduction of quality of crops, which violates the natural development law of the soil ecological environment, so that it is an important means for the fertilizer industry to achieve sustainable development to create novel fertilizers, reasonably apply the fertilizers, improve the comprehensive utilization efficiency of the fertilizers and activate the soil life.

### SUMMARY

The technical problem to be solved by the present invention is to provide a safe and environment-friendly composite fertilizer aiming at the defects in the prior art. The inventors have found that both polyglutamic acid and magnesium ammonium phosphate have a significant synergistic effect on promoting plant growth and increasing crop yield. Meanwhile, both of the two have good complementary effects on the aspects of providing nutrient absorption and utilization for crops.

Another objective of the present invention is to provide a preparation method of a composite fertilizer containing polyglutamic acid and magnesium ammonium phosphate and application thereof in promoting plant growth and improving crop yield in the agricultural field.

The Objectives of the Present Invention can be Achieved by the Following Measures:

A composite fertilizer includes two functional components of polyglutamic acid and magnesium ammonium phosphate. A weight ratio of the polyglutamic acid to the magnesium ammonium phosphate is 1:100 to 10000. In a preferred embodiment, in order to make the effect more obvious, the weight ratio of the two is further preferably 1:150 to 8000.

Further, according to the use of the present invention, the composite fertilizer can be applied as a trace element fertilizer with a weight ratio of the polyglutamic acid to the magnesium ammonium phosphate of 1:100 to 1200, preferably 200 to 1000. When the composite fertilizer is used as a base fertilizer or top dressing, the weight ratio of the polyglutamic acid to the magnesium ammonium phosphate is 1:1000 to 10000, preferably 1:1500 to 8000.

In one technical solution of the present invention, in order to improve fertilizer effect and activate soil, a microbial agent or a mixture of more than one known microbial agents can be added. Suitable microorganisms include, but are not limited to, Bacillus subtilis, Trichoderma harzianum, Rhizobium, Bacillus thuringiensis, Paecilomyces lilacinus, preferably Bacillus subtilis and Trichoderm aharzianum. In the present invention, a total effective viable count is greater than 20 million/gram, and in order to further improve the use effect, it is preferable that the total effective viable count of microbial bacteria is greater than 200 million/gram, and it is further preferable that the total effective viable count of microbial bacteria is greater than 1 billion/gram.

Further, an organic matter is contained in the composite fertilizer containing polyglutamic acid and magnesium ammonium phosphate. A content of the organic matter is greater than 8%, and preferably greater than 20%. Suitable organic matter includes, but is not limited to, one or a mixture of more of cellulose, hemicellulose, proteins, humic acids, lipids, asphaltenes, resins and gums, tannins, steroids, vitamins, terpenes, and humins. Or fertilizers containing organic matters (such as livestock manure, municipal waste organic matters, sludge, straw, sawdust, food processing wastes and the like) and substances containing organic matters (turf, weathered coal, lignite, humic acid and the like), and microbial agents or substances stimulating growth, such as urea and the like can also be added.

When the fertilizer is used as a trace element fertilizer, other macroelements, medium elements or trace elements can be added compositely. According to the growth requirements of different crops and soil moisture, different kinds or quantities of trace elements are added or mixed and applied.

In the present invention, the trace elements refer to essential nutrient elements for plant growth, including 11 kinds of sulfur, potassium, calcium, iron, manganese, zinc, copper, boron, molybdenum, chlorine and nickel, and in addition, some plants also need silicon, sodium and cobalt, which are called beneficial elements.

The potassium fertilizer includes, but is not limited to, potassium chloride, potassium sulfate, monopotassium phosphate, sylvite, potassium magnesium salt, carnallite, potassium nitrate or kiln dust potassium fertilizer and the like, preferably monopotassium phosphate.

The manganese fertilizer includes, but is not limited to, manganese sulfate, manganese chloride or organic chelated manganese and the like.

The iron fertilizer includes, but is not limited to, an inorganic iron fertilizer, an organic iron fertilizer, or a chelated iron fertilizer. Suitable inorganic iron fertilizers may include ferrous sulfate, ferric sulfate, ferric oxide, ferrous carbonate, or ferrous ammonium phosphate monohydrate; suitable organic iron fertilizers include hexaurea iron trinitrate or diamine iron fulvate.

The copper fertilizers include, but are not limited to, copper sulfate, cuprous oxide, chelated copper or copper-containing slag, and the like.

The boron fertilizers include, but are not limited to, borax or boric acid.

The zinc fertilizers include, but are not limited to, zinc sulfate, zinc oxide, zinc nitride, or chelated zinc, preferably zinc sulfate.

The sulfur fertilizers include, but are not limited to, ammonium sulfate, calcium super phosphate, potassium sulfate, or a sulfur fertilizer, and the sulfur fertilizer may include ammonium thiosulfate, sulfur-urea, or liquid sulfur dioxide.

The cobalt fertilizers include, but are not limited to, cobalt sulfate, cobalt chloride, or chelated cobalt fertilizers (e.g., humic acid-chelated cobalt fertilizers, fulvic acid-chelated cobalt fertilizers, sugar alcohol type cobalt fertilizers and the like).

The silicon fertilizers include, but are not limited to, silicon ore, silicate or citrate-soluble mineral fertilizers containing calcium silicate as the main component.

The calcium fertilizers include, but are not limited to, lime (including quicklime, slaked lime, limestone powder and the like) or calcium phosphate fertilizers, such as calcium magnesium phosphate fertilizer, calcium super phosphate and the like, and some of calcium nitrogen fertilizers such as calcium nitrate, lime nitrogen and the like, as well as dolomite (including complex calcium salts of calcium carbonate and magnesium carbonate) and calcined products thereof (calcium oxide and calcium hydroxide).

The macroelements, medium elements or trace elements are comprehensively considered to be added according to characteristics of the crops, soil moisture and environmental characteristics, and application technologies of the elements are all public technologies in the industry.

Polyglutamic acid (PGA) is mainly formed by polymerizing D-glutamic acid and L-glutamic acid through amide bonds, and is mainly includes two constructions due to different polymerization modes: α-polyglutamic acid (polymerized by α-amide bond, α-PGA) and γ-polyglutamic acid (polymerized by γ-amide bond, γ-PGA), the form of polyglutamic acid in the present invention is γ-polyglutamic acid, which is “polyglutamic acid” for short (the structural formula thereof is shown below) in the present invention.

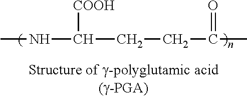

The polyglutamic acid in the present invention can be a γ-polyglutamic acid solution, or a γ-polyglutamic acid pure product or a salt pure product thereof, and can also be a fermentation culture containing γ-polyglutamic acid, or γ-polyglutamic acid powder containing a fermentation bacterial agent; based on the γ-polyglutamic acid contained therein, the γ-polyglutamic acid has an average molecular weight of 20-3000 KDa, and the γ-polyglutamic acid solution is preferred.

Through experiments, the inventors found that the composite fertilizer containing polyglutamic acid and magnesium ammonium phosphate can better regulate the growth of crops, promote the health effect of the crops and increase the yield of the crops.

The present invention provides application of a composition comprising a component A (magnesium ammonium phosphate) and a component B (polyglutamic acid) in regulating the growth of crops in the agricultural field, and particularly has a remarkable application effect in improving the yield of crops.

According to the present invention, the polyglutamic acid and the magnesium ammonium phosphate are combined to have hydrophilic and water-retaining properties, so that a layer of film can be formed on the surface layer of plant root hairs, on one hand, the root hairs are protected, on the other hand, fertilizer loss can be slowed down, and meanwhile, the acid-base value of soil can be effectively balanced. Meanwhile, in the composition, polyglutamic acid is a biodegradable polypeptide macromolecular polymer, is safe and environment-friendly, can be gradually degraded into glutamic acid required by plant growth regulation by microorganisms in a natural soil environment, and can effectively promote crop growth, improve the disease resistance, improve the quality and increase the yield.

In order to give full play to the advantageous effects of the present invention, the composition of the present invention can also be mixed with other pesticides (such as bactericides, insecticides, herbicides, plant growth regulators), fertilizers and the like, all of which are commonly used pesticides or fertilizers disclosed in the prior art.

The composite fertilizer is of a solid shape. Depending on the subject to be applied, it may be processed into granular, tablet, particulate or powder forms, preferably granular and powder forms.

In one processing technical solution of the present invention, the method includes the following steps: (1) pulverizing magnesium ammonium phosphate to in 20-70 meshes; (2) granulating, oven drying and cooling the pulverized magnesium ammonium phosphate; (3) evenly spraying polyglutamic acid liquid according to a weight ratio of polyglutamic acid to magnesium ammonium phosphate of 1:50 to 15000 (preferably 1:100 to 10000); (4) oven drying the fertilizer granules; and (5) quantitatively packaging to obtain the granular composite fertilizer.

Alternatively, (1) pulverizing magnesium ammonium phosphate into 20-70 meshes; (2) evenly spraying polyglutamic acid liquid according to a weight ratio of polyglutamic acid to pulverized magnesium ammonium phosphate of 1:50 to 15000 (preferably 1:100 to 10000); (3) oven drying; and (4) quantitatively packaging to obtain the composite fertilizer powder.

In another processing technical solution of the present invention, the microbial agent can be added to obtain the compound microbial fertilizer, and the processing method specifically includes the following steps: (1) pulverizing magnesium ammonium phosphate into 10-70 meshes; (2) granulating, oven drying and cooling the pulverized magnesium ammonium phosphate; (3) evenly spraying polyglutamic acid liquid according to a weight ratio of polyglutamic acid to magnesium ammonium phosphate of 1:50 to 15000 (preferably 1:100 to 10000); (4) evenly mixing one or more microbial agents of purchased or cultured Bacillus subtilis, Trichoderma harzianum, rhizobium, Bacillus thuringiensis and Paecilomyces lilacinus, evenly mixing and stirring the microbial agent and polyglutamic acid-magnesium ammonium phosphate granules, so that the effective viable count per gram of fertilizer is not less than 20 million (preferably not less than 200 million per gram of fertilizer); (5) oven drying the fertilizer granules; and 6) quantitatively packaging to obtain the granular compound microbial fertilizer.

In the processing technical solution, organic matters can be added after step 4, the content of the organic matters is higher than 8%, and the organic matters are preferably cellulose, hemicellulose, protein and humic acid.

In one processing technical solution, alternatively, (1) directly pulverizing magnesium ammonium phosphate into 10-70 meshes; (2) evenly spraying polyglutamic acid liquid according to a weight ratio of polyglutamic acid to magnesium ammonium phosphate of 1:100 to 10000; (3) evenly mixing one or more microbial agents of purchased or cultured Bacillus subtilis, Trichoderna harzianum, rhizobium, Bacillus thuringiensis and Paecilomyces lilacinus, evenly mixing and stirring the microbial agent and polyglutamic acid-magnesium ammonium phosphate granules, so that the effective viable count per gram of fertilizer is not less than 20 million (preferably not less than 200 million per gram of fertilizer); (4) oven drying the fertilizer; and (5) quantitatively packaging to obtain the compound microbial fertilizer powder.

In the powder processing technical solution, organic matters can be added after step 3, the content of the organic matters is higher than 8%, and the organic matters are preferably cellulose, hemicellulose, protein and humic acid.

In another processing technical solution, according to the actual soil structure and different crop growth requirements, a proper amount of macro elements, medium elements and trace elements can be added to obtain the compound microbial fertilizer, the specific processing method includes the following steps: (1) according to the requirements of crops, selecting a proper amount of macro elements, medium elements or trace elements types, and pulverizing respectively with the magnesium ammonium phosphate into 10-70 meshes; (2) adding the pulverized raw materials into a feeding port, setting a dosage ratio, carrying out mixing granulation according to a certain ratio, granulating, oven drying and cooling; (3) evenly spraying polyglutamic acid liquid according to a weight ratio of polyglutamic acid to magnesium ammonium phosphate of 1:100 to 10000; (4) separately using or mixing one or more microbial agents of purchased or cultured Bacillus subtilis, Trichoderma harzianum, rhizobium, Bacillus thuringiensis and Paecilomyces lilacinus, evenly mixing and stirring the microbial agent with polyglutamic acid-magnesium ammonium phosphate granules, so that the effective viable count per gram of fertilizer is not less than 20 million (preferably not less than 200 million per gram of fertilizer); (5) oven drying the fertilizer granules; and (6) quantitatively packaging to obtain the granular compound microbial fertilizer.

In the processing technical solution, according to the actual soil structure and different crop growth requirements, organic matters can be added after step 4, the content of the organic matters is higher than 8%, and the organic matters are preferably cellulose, hemicellulose, protein and humic acid.

In a powder processing solution, the method includes the following steps: (1) according to the requirements of crops, selecting a proper amount of macro elements, medium elements or trace elements types, and pulverizing respectively with the magnesium ammonium phosphate into 10-70 meshes; (2) adding the pulverized raw materials into a feeding port, setting a dosage ratio, and evenly stirring according to a certain ratio; (3) evenly spraying polyglutamic acid liquid according to a weight ratio of polyglutamic acid to magnesium ammonium phosphate of 1:100 to 10000; (4) separately using or mixing one or more microbial agents of purchased or cultured Bacillus subtilis, Trichoderma harzianum, rhizobium, Bacillus thuringiensis and Paecilomyces lilacinus, evenly mixing and stirring the microbial agent with polyglutamic acid-magnesium ammonium phosphate granules, so that the effective viable count per gram of fertilizer is not less than 20 million (preferably not less than 200 million per gram of fertilizer); (5) oven drying the fertilizers; and (6) quantitatively packaging to obtain the compound microbial fertilizer powder.

In the processing technical solution, according to the actual soil structure and different crop growth requirements, organic matters can be added after step 4, the content of the organic matters is higher than 8%, and the organic matters are preferably cellulose, hemicellulose, protein and humic acid.

The polyglutamic acid and the magnesium ammonium phosphate in the composition disclosed by the present invention have mutual synergistic promotion effects as follows: 1. the present invention can improve the balance of acidic soils. Most of the traditional nitrogen and phosphorus fertilizers are acid fertilizers, and long-term application can increase the acidity of soil and cause crop yield reduction or nutrient deficiency. In the present invention, the combination of polyglutamic acid and magnesium ammonium phosphate can effectively reduce soil nitrogen leaching loss, and has the effects of relieving soil acidification and the like. The slow control effect of polyglutamic acid can obviously reduce nitrogen leaching loss of magnesium ammonium phosphate, the release amount of N₂O can be obviously reduced, more lasting effective nutrients can be provided for the growth of plants, the release of NH₃—N in magnesium ammonium phosphate sediment is relatively slow, and the leaching amount of NH₃—N is gradually reduced. After being applied into the soil, the nitrogen and phosphorus leaching amount of the magnesium ammonium phosphate is obviously lower than that of other fertilizers, especially nitrogen leaching, and the pH value of the soil is increased to a certain extent, so that the pH value of the soil can be increased; 2. fertilizer-in-water is realized, the fertilizer and water are integrated, so that the loss of water and fertilizer is reduced, and the stress tolerance of crops is improved; 3. trace elements are chelated. In the application process of the conventional fertilizer, the utilization rate is not high, and the absorption and utilization of magnesium ammonium phosphate by crops can be improved by adding polyglutamic acid; 4. the photosynthesis efficiency of the plants is improved. The fertilizer disclosed by the present invention can increase the leaf area of crops, thereby increasing the photosynthesis efficiency of the crop leaves; and 5. the slow release and slow control effects are good. The magnesium ammonium phosphate has certain slow release property, the polyglutamic acid is also a good slow release agent, through the combination of the polyglutamic acid and the magnesium ammonium phosphate, the slow release rate of the magnesium ammonium phosphate can be better adjusted, and the combination of the polyglutamic acid and the magnesium ammonium phosphate has a good environmental effect.

### DETAILED DESCRIPTION

To make the objectives, the technical solutions, and the advantages of the present invention clearer, the following further describes the present invention in detail with reference to the embodiments. It should be understood that the specific embodiments described herein are merely used to explain the present invention, and are not intended to limit the present invention. Any modification, equivalent replacement, or improvement made within the spirit and principle of the present invention shall fall within the protection scope of the present invention.

The percentages in all formulations of the following embodiments are in weight percent (converted to 100%). Various processing technologies of the composite fertilizer are the prior art, and can be changed according to different conditions.

### I. Embodiments

(I) Fertilizers prepared by a processing method of a solid preparation in the present specification and fertilizer efficiency experiments thereof

TABLE 1
1. Fertilizers prepared by the processing method of
the solid preparation in the present specification

| | Ingredients and contents | | | | | |
|---|---|---|---|---|---|---|
| | contained | | | | | |
| | | | Magnesium | | | |
| | Polyglutamic | | ammonium | | Propor- | Dosage |
| Embodiment | acid | | phosphate | | tioning | form |
| Embodiment 1 | 20 | g | 2 | kg | 1:100 | Powder |
| Embodiment 2 | 10 | g | 2 | kg | 1:200 | Powder |
| Embodiment 3 | 20 | g | 5 | kg | 1:250 | Powder |
| Embodiment 4 | 10 | g | 5 | kg | 1:500 | Powder |
| Embodiment 5 | 10 | g | 10 | kg | 1:1000 | Powder |
| Embodiment 6 | 10 | g | 15 | kg | 1:1500 | Powder |
| Embodiment 7 | 12 | g | 9.6 | kg | 1:800 | Powder |
| Embodiment 8 | 12 | g | 12 | kg | 1:1000 | Powder |
| Embodiment 9 | 10 | g | 20 | kg | 1:2000 | Granules |
| Embodiment 10 | 10 | g | 30 | kg | 1:3000 | Granules |
| Embodiment 11 | 10 | g | 40 | kg | 1:4000 | Granules |
| Embodiment 12 | 15 | g | 75 | kg | 1:5000 | Granules |
| Embodiment 13 | 18 | g | 108 | kg | 1:6000 | Granules |
| Embodiment 14 | 18 | g | 126 | kg | 1:7000 | Granules |
| Embodiment 15 | 16 | g | 128 | kg | 1:8000 | Granules |
| Embodiment 16 | 14.22 | g | 128 | kg | 1:9000 | Granules |

2. Field Fertilizer Efficiency Experiment

(1) The solid fertilizers prepared in Embodiments 1-8 of the present invention were used to verify the growth and yield-increasing effects on tobaccos.

Variety Yunnan tobacco PV1H1452, tested in Group 2, Hetou Village, Longshan Town, Longling County, Yunnan Province, had moderate fertility, pH 5.31, organic mater 3.51%, available nitrogen 121.5 mg/kg, available phosphorus 35.18 mg/kg, available potassium 82.6 mg/kg, available zinc 1.8 mg/kg, exchangeable calcium 640 mg/kg and exchangeable magnesium 24.2 mg/kg.

Application amount: the composite fertilizer of the present invention was used in an amount of 10 kilograms per mu, the control fertilizer magnesium ammonium phosphate was used separately in an amount of 10 kilograms per mu, and the polyglutamic acid was used separately in an amount of 10 g, 50 g and 100 g per mu respectively. Other fertilizers were applied at a standard 90 kg/hm² of pure nitrogen, m(N):m(P₂O₅):m(K₂)=1:1:2. Randomized block design was repeated 3 times. The plot area was 40 m² and the distance between row and hill was 1.0 m*0.4 m. Protection rows were arranged around the plot. The composite fertilizer disclosed by the present invention was applied at one time along with other base fertilizers.

The leaf color and growth of tobacco seedlings 12 days after transplantation were observed, and the leaf thickness, the number of effective leaves per plant, the weight of fresh leaves per leaf and the proportion of high-quality tobacco were observed. After each treated tobacco plant was toped, 15 representative tobacco plants were selected, and marked as observation plants, each of the tobacco plant was marked at four lower leaves, four middle leaves and four upper leaves for biological characteristic investigation, and the fresh weight of a single leaf was investigated during harvesting; the number of the effective leaves per plant was investigated before harvesting for primary curing. The marked leaves and non-marked leaves in each plot were respectively collected, baked and graded. The number of tobacco plants harvested was investigated before the primary curing and used to calculate the yield. The fresh weight was obtained immediately after the tobacco leaves were harvested, and the leaves were then hung grading tags for baking. During grading, the weight and the number of leaves of each grade of tobacco leaves were recorded in time, each of the marked leaves was graded, then bundled according to plots and sites as a sample for analysis, and then the average yield of dry tobacco leaves and the proportion of high-quality and medium quality tobacco leaves were counted. At the same time, the stress tolerance of tobacco growth (i.e., the occurrence degree of tobacco black shank) was monitored.

Leaf thickness: leaf thickness relative to normal (CK).

TABLE 2
Summary table of experiment data for tobacco growth promotionof embodimentsof the present invention

| | | | | | | | | Proportion of | |
|---|---|---|---|---|---|---|---|---|---|
| | | | | | | | | high-quality | |
| | 12 days after | | 5 days | | | Number of | | and medium | Occurrence |
| | transplantation | | after topping | | | effective | Fresh leaf | quality | degree of |
| | Leaf | | Leaf | | Leaf | leaves | weight) per | tobacco | tobacco |
| Embodiment | color | Growth | color | Growth | Thickness | per plant | plant (kg) | leaves (%) | black shank |
| Embodiment 1 | Dark | Strong | Darkgreen | Strong | Relatively | 21.2 | 6.3 | 88.5 | None |
| | | | | | thick | | | | |
| Embodiment 2 | Dark | Strong | Darkgreen | Strong | Relatively | 21.5 | 6.2 | 88.6 | None |
| | | | | | thick | | | | |
| Embodiment 3 | Dark | Strong | Darkgreen | Strong | Relatively | 22.0 | 6.4 | 89.0 | None |
| | | | | | thick | | | | |
| Embodiment 4 | Dark | Strong | Darkgreen | Strong | Relatively | 22.1 | 6.7 | 89.6 | None |
| | | | | | thick | | | | |
| Embodiment 5 | Dark | Strong | Darkgreen | Strong | Relatively | 22.4 | 6.5 | 89.2 | None |
| | | | | | thick | | | | |
| Embodiment 6 | Dark | Strong | Darkgreen | Strong | Relatively | 22.5 | 6.8 | 90.1 | None |
| | | | | | thick | | | | |
| Embodiment 7 | Dark | Strong | Darkgreen | Strong | Relatively | 23.0 | 6.3 | 88.5 | None |
| | | | | | thick | | | | |
| Embodiment 8 | Dark | Strong | Darkgreen | Strong | Relatively | 21.2 | 6.6 | 89.3 | None |
| | | | | | thick | | | | |
| Magnesium | Shallow | Relatively | Lightgreen | Medium | Normal | 20.5 | 5.8 | 86.3 | Light |
| ammonium | | weak | | | | | | | |
| phosphate | | | | | | | | | |
| Polyglutamic | Shallow | Relatively | Yellow | Relatively | Relatively | 20.0 | 5.5 | 85.5 | Moderate |
| acid 10 g/mu | | weak | green | weak | thin | | | | |
| Polyglutamic | Shallow | Relatively | Yellow | Relatively | Relatively | 20.3 | 5.4 | 85.8 | Light |
| acid50 g/mu | | weak | green | weak | thin | | | | |
| Polyglutamic | Lightgreen | Strong | Yellow | Medium | Relatively | 20.6 | 5.6 | 86.0 | Light |
| acid 100 g/mu | | | green | | thin | | | | |
| Normal (CK) | Lightgreen | Weak | The leaf | Weak | Relatively | 19.2 | 5.1 | 78.2 | Severe |
| | | | vein is | | thin | | | | |
| | | | yellow | | | | | | |
| | | | green | | | | | | |
| | | | and the | | | | | | |
| | | | leaf is | | | | | | |
| | | | whitish | | | | | | |

As can be seen from the experimental results in Table 2, the combined application of magnesium ammonium phosphate and polyglutamic acid can promote the growth of tobacco plants to be more strong, increase the weight per leaf of fresh tobacco, increase the number of effective leaves per plant and increase the yield and quality of tobacco leaves. Separate application of magnesium ammonium phosphate and polyglutamic acid was less effective. The polyglutamic acid and the magnesium ammonium phosphate have good synergism, the polyglutamic acid can reduce the loss of the magnesium ammonium phosphate in soil and effectively promote the absorption and conversion utilization of the magnesium ammonium phosphate by crops. When magnesium ammonium phosphate is applied alone, the tobacco plants absorb magnesium ions slowly, the utilization rate is low, the tobacco leaves are light green, and the theoretical application effect is not achieved. When polyglutamic acid is applied alone, the polyglutamic acid cannot replace magnesium, although the polyglutamic acid can promote the function of absorbing part of magnesium ions in soil of the tobacco plants, if the magnesium ions in the soil are insufficient, the tobacco plants will still be in nutrient deficiency, and therefore the tobacco leaves applied with the polyglutamic acid in the experiment are yellow green and in slight magnesium deficiency. However, the conventional control was completely labeled as magnesium deficiency of tobacco plants, the lower leaves turned from green to yellow, the edges and tips of leaves began to turn yellow and extend upward, for some tobacco plants suffering from serious magnesium deficiency, except the veins of leaves remained green and yellow green, the leaves all turned white, and the tips of leaves suffered from brown necrosis.

(2) The solid fertilizers prepared in Embodiments 9-16 of the present invention were used to verify the growth and yield-increasing effects on panaxnotoginseng.

The experiment was carried out in a panaxnotoginseng planting base in Gumu Town, Wenshan City, Yunnan Province. Soil fertility was moderate, pH 5.54, organic matter 9.42 mg/kg, available nitrogen 112.4 mg/kg, available phosphorus 14.35 mg/kg, available potassium 65.2 mg/kg, available zinc 2.1 mg/kg, exchangeable calcium 523 mg/kg, and exchangeable magnesium 15.6 mg/kg.

Application amount: the composite fertilizer of the present invention was used in an amount of 100 kilograms per mu, the control fertilizer ammonium magnesium phosphate was used separately in an amount of 100 kilograms per mu, polyglutamic acid was used separately in an amount of 15 g, 30 g and 60 g per mu respectively, other nitrogen and phosphorus fertilizers were not applied, and the conventional potassium fertilizer and the conventional trace element fertilizer were used in the later period. Randomized block design was repeated 3 times. The plot area was 20 m² (4 m*5 m). The fertilizer of the present invention was evenly mixed with the conventional fertilizer and then was spread.

During the growing process of the panaxnotoginseng, the plant height and stem base diameter of the panaxnotoginseng plant were traced and measured and the leaf area was measured, and the fresh yield and weight of stem leaves and root tubers were measured after harvesting. The weight, yield-increasing rate and dry weight ratio of root tubers of panaxnotoginseng were determined after oven drying.

Yield−increasing rate %=(harvested weight of actually treated plot−harvested weight of control plot)/harvested weight of control plot*100%

Dry weight ratio (%)=dry weight/fresh weight*100%

TABLE 3
Summary table of experiment data for panaxnotoginseng
growth promotionof embodimentsof the present invention

| | | | | | | Dry yield (kg/mu) | | |
|---|---|---|---|---|---|---|---|---|
| | 5 days before digging | | Fresh yield (kg/mu) | | | | | Dry |
| | | Stem base | Leaf | | | | Yield- | weight |
| | Plantheight | diameter | area | Stem | | Root | increasing | ratio |
| Embodiment | (cm) | (mm) | (cm²) | leaf | Roottuber | tuber | rate(%) | (%) |
| Embodiment9 | 36.38 | 6.88 | 225.25 | 164.41 | 386.24 | 115.12 | 41.44 | 29.81 |
| Embodiment10 | 38.05 | 7.21 | 231.37 | 166.52 | 423.98 | 126.08 | 54.91 | 29.74 |
| Embodiment11 | 37.59 | 6.97 | 226.14 | 162.73 | 401.15 | 118.42 | 45.50 | 29.52 |
| Embodiment12 | 36.85 | 7.02 | 229.19 | 168.98 | 405.18 | 121.68 | 49.50 | 30.03 |
| Embodiment13 | 37.13 | 6.92 | 222.36 | 156.37 | 379.01 | 114.49 | 40.67 | 30.21 |
| Embodiment14 | 37.02 | 6.87 | 228.05 | 167.29 | 392.17 | 120.84 | 48.47 | 30.81 |
| Embodiment15 | 36.17 | 6.94 | 224.38 | 162.07 | 384.39 | 116.51 | 43.15 | 30.31 |
| Embodiment16 | 36.15 | 6.82 | 221.74 | 160.53 | 380.97 | 112.38 | 38.08 | 29.50 |
| Magnesium | 34.23 | 6.61 | 200.15 | 135.59 | 341.84 | 94.29 | 15.85 | 27.58 |
| ammonium | | | | | | | | |
| phosphate single | | | | | | | | |
| agent | | | | | | | | |
| Polyglutamic | 33.18 | 6.41 | 188.19 | 117.43 | 315.85 | 85.74 | 5.34 | 27.15 |
| acid15 g/mu | | | | | | | | |
| Polyglutamic | 33.61 | 6.48 | 191.02 | 125.37 | 322.98 | 87.56 | 7.58 | 27.11 |
| acid30 g/mu | | | | | | | | |
| Polyglutamic | 34.05 | 6.57 | 198.51 | 130.65 | 331.72 | 92.03 | 13.07 | 27.74 |
| acid60 g/mu | | | | | | | | |
| Normal (CK) | 31.17 | 6.35 | 184.38 | 111.34 | 310.91 | 81.39 | — | 26.18 |

As can be seen from the experimental results in Table 3, when magnesium ammonium phosphate and polyglutamic acid were applied together, the plant height of the panaxnotoginseng plant can be increased, the stem base can be increased, and therefore the lodging resistance of the panaxnotoginseng can be improved. Meanwhile, the leaf area of the panaxnotoginsengis obviously increased by the composite fertilizer, the photosynthesis efficiency is improved, and the effect of increasing the yield is achieved. Separate application of magnesium ammonium phosphate and polyglutamic acid was less effective.

(II) Composite Fertilizers Prepared by the Processing Method of the Solid Preparation in the Present Specification and Fertilizer Efficiency Experiments Thereof

TABLE 4
1. Granular composite fertilizer and composite fertilizer powderprepared by
the processing method of the solid preparation in the present specification

| | Ingredients and contents contained | | | | | |
|---|---|---|---|---|---|---|
| | | | Bacteria and | | | |
| | | | effective viable count | | | |
| | | | | Effective | | |
| | | Magnesium | | viable | Organic | |
| | Polyglutamic | ammonium | | count (in 100 | matter and | Dosage |
| Embodiment | acid | phosphate | Bacteria | million/gram) | content | form |
| Embodiment 17 | 10 | 2000 | Bacillus subtilis | 500 | Humicacid, 40% | Powder |
| Embodiment 18 | 10 | 4000 | Trichoderma | 500 | Cellulose, 40% | Granules |
| | | | harzianum | | | |
| Embodiment 19 | 10 | 5000 | Bacillus subtilis + | 400 + 100 | Protein, 40% | Granules |
| | | | Trichoderma | | | |
| | | | harzianum | | | |
| Embodiment 20 | 10 | 7000 | Trichoderma | 200 | Peat, 30% | Powder |
| | | | harzianum | | | |
| Embodiment 21 | 10 | 9000 | Bacillus subtilis | 200 | Cellulose, 30% | Powder |
| Embodiment 22 | 10 | 10000 | Bacillus subtilis + | 130 + 70 | Humic acid, 30% | Powder |
| | | | Trichoderma | | | |
| | | | harzianum | | | |
| Embodiment 23 | 10 | 20000 | Bacillus subtilis | 100 | Protein, 20% | Granules |
| Embodiment 24 | 12 | 30000 | Trichoderma | 100 | Humic acid, 20% | Powder |
| | | | harzianum | | | |
| Embodiment 25 | 12 | 40000 | Bacillus subtilis + | 20 + 80 | Cellulose, 20% | Granules |
| | | | Trichoderma | | | |
| | | | harzianum | | | |
| Embodiment 26 | 12 | 50000 | Bacillus subtilis | 50 | Peat, 15% | Granules |
| Embodiment 27 | 12 | 60000 | Trichoderma | 50 | Peat, 15% | Powder |
| | | | harzianum | | | |
| Embodiment 28 | 12 | 70000 | Bacillus subtilis + | 40 + 10 | Peat, 15% | Granules |
| | | | Trichoderma | | | |
| | | | harzianum | | | |
| Embodiment 29 | 12 | 80000 | Trichoderma | 5 | Humic acid, 8% | Granules |
| | | | harzianum | | | |
| Embodiment 30 | 12 | 90000 | Bacillus subtilis | 5 | Cellulose, 8% | Granules |
| Embodiment 31 | 12 | 100000 | Bacillus subtilis + | 1 + 1 | Protein, 8% | Granules |
| | | | Trichoderma | | | |
| | | | harzianum | | | |
| Embodiment 32 | 12 | 120000 | Bacillus subtilis + | 1 + 1 | Humic acid, 8% | Powder |
| | | | Trichoderma | | | |
| | | | harzianum | | | |

2. Field Fertilizer Efficiency Verification Experiment of the Present Invention

(1) The embodiments prepared by the present invention were used for verifying the yield-increasing experiment for lyciumbarbarum.

The experiment was carried out in an organic lyciumbarbarum planting base in Yuanzhou District, Guyuan City, Ningxia Hui Autonomous Region. PH value of the tested soil was 5.41, organic matter content was 3.13%, total nitrogen content was 0.2160, total phosphorus content was 0.16%, total potassium content was 6.52%, available nitrogen content was 47.31 mg/kg, available phosphorus content was 11.23 mg/kg, and available potassium content was 167.32 mg/kg. The tested variety of lyciumbarbarum was ‘NINGQI No. 7’, the tree was 5 years old, the distance between row and hill was 2 m, and generally, the overall tree vigor was substantially balanced.

The base fertilizer was applied with other conventional fertilizers using an annular furrow application method (i.e., an annular furrow of 70 cm wide and 60 cm deep was excavated 40 cm from the root neck of the tree). The fertilizer of the present invention was applied in an amount of 50 kg per mu. The control treatment magnesium ammonium phosphate was separately applied in an amount of 50 kilograms per mu, polyglutamic acid was separately applied in an amount of 50 g, 100 g and 200 g per mu respectively, and microbial agents of Bacillus subtilis, Trichoderma harzianum and a mixture of Bacillus subtilis and Trichoderma harzianum were separately applied in an amount of 50 kilograms (the effective viable count was greater than 2 billion/gram). Three plants were selected for each treatment, repeated three times, each plot was randomly arranged, and other field management measures were consistent. In the experiment, the marked plants were selected, hung with labels, the weight of each treatment on lyciumbarbarum hair root system (weighing after oven drying), the weight of one hundred fresh fruits were measured one by one from bottom to top, the growth of lyceumbarbarum fruits was observed, the yield per mu of the fresh fruits was measured, and the disease condition of each treatment was investigated.

TABLE 5
Effect of the composite fertilizer prepared in the embodimentsof the
present invention on growth and yield increase of lyciumbarbarum

| | | | | | Fresh fruit harvesting | | | |
|---|---|---|---|---|---|---|---|---|
| | | | | Weight | amount | | | |
| | | | Root dry | ofonehundred | | Yield- | | |
| | Leaf | Plantheight | mass | fresh | Yield | increasing | Polysaccharide | Occurrenceof |
| Embodiment | color | (cm) | (g/plant) | fruits (g) | (kg/mu) | rate (%) | content (%) | root rot |
| Embodiment 17 | Dark | 131.3 | 362.3 | 150.6 | 3508.2 | 45.7 | 41.93 | Not occurred |
| | green | | | | | | | |
| Embodiment 18 | Dark | 129.1 | 366.1 | 152.7 | 3621.7 | 50.4 | 42.17 | Not occurred |
| | green | | | | | | | |
| Embodiment 19 | Dark | 130.8 | 358.2 | 148.9 | 3567.8 | 48.1 | 40.18 | Not occurred |
| | green | | | | | | | |
| Embodiment 20 | Dark | 126.5 | 359.4 | 149.6 | 3507.2 | 45.6 | 41.34 | Not occurred |
| | green | | | | | | | |
| Embodiment 21 | Dark | 128.8 | 342.9 | 147.8 | 3481.1 | 44.5 | 40.14 | Not occurred |
| | green | | | | | | | |
| Embodiment 22 | Dark | 125.2 | 347.6 | 142.9 | 3413.5 | 41.7 | 42.07 | Not occurred |
| | green | | | | | | | |
| Embodiment 23 | Dark | 126.7 | 339.8 | 138.2 | 3352.9 | 39.2 | 41.69 | Not occurred |
| | green | | | | | | | |
| Embodiment 24 | Dark | 124.5 | 341.3 | 132.9 | 3241.4 | 34.6 | 40.23 | Not occurred |
| | green | | | | | | | |
| Embodiment 25 | Dark | 122.4 | 338.5 | 130.8 | 3207.5 | 33.2 | 42.31 | Not occurred |
| | green | | | | | | | |
| Magnesium | Green | 113.8 | 288.9 | 108.5 | 3037.4 | 26.1 | 38.57 | Significantly |
| ammonium | | | | | | | | occurred |
| phosphate | | | | | | | | |
| Polyglutamic | Green | 107.5 | 271.5 | 97.8 | 2736.7 | 13.6 | 37.26 | Significantly |
| acid50 g/mu | | | | | | | | occurred |
| Polyglutamic | Green | 111.4 | 285.3 | 105.9 | 2841.1 | 18.0 | 38.19 | Slightly |
| acid 100 g/mu | | | | | | | | occurred |
| Polyglutamic | Green | 115.7 | 298.7 | 109.3 | 2908.8 | 20.8 | 38.24 | Slightly |
| acid 200 g/mu | | | | | | | | occurred |
| Bacillus subtilis | Green | 106.8 | 277.5 | 106.2 | 2607.0 | 8.2 | 38.08 | Slightly |
| | | | | | | | | occurred |
| Trichoderma | Green | 108.3 | 286.5 | 104.2 | 2568.9 | 6.7 | 38.54 | Slightly |
| harzianum | | | | | | | | occurred |
| Bacillus subtilis + | Green | 109.5 | 279.8 | 103.5 | 2797.6 | 16.2 | 38.38 | Slightly |
| Trichoderma | | | | | | | | occurred |
| harzianum | | | | | | | | |
| Normal (CK) | Light | 101.6 | 257.7 | 92.8 | 2408.5 | — | 36.97 | Severely |
| | green | | | | | | | occurred |

As can be seen from the experimental results in Table 5, co-application of magnesium ammonium phosphate, polyglutamic acid and microbial agents can improve the growth of lyciumbarbarum plants, mainly in improving the plant height of lyciumbarbarum, increasing the number of root hairs (root dry mass) of lyciumbarbarum, facilitating the nutrient absorption and transmission of root systems, and forming a benign circular growth of lyciumbarbarum. The composite fertilizer disclosed by the present invention can increase the single seed of lyciumbarbarum, increase the yield of lyciumbarbarum, obviously improve the sugar content of lyciumbarbarum, improve the variety of lyciumbarbarum, has a good control effect on soil-borne diseases of lyciumbarbarum, and reduces the application amount of pesticides. Separate application of magnesium ammonium phosphate and polyglutamic acid was general in effect.

(2) the Embodiments Prepared by the Present Invention were Used for Verifying the Yield-Increasing Effect on Citrus

The experiment was carried out in a citrus orchard in Huashutownship, Kecheng District, Quzhou City, Zhejiang Province. PH value of the tested soil was 5.7, organic matter 12.4 mg/kg, total nitrogen 2.6 mg/kg, available phosphorus 12.1 mg/kg, and available potassium 101 mg/kg. The tested crop variety was “HONGMEIREN”. Four treatments were arranged for the experiment and repeated three times. 5 citrus trees per plot with an area of 40 m². The fertilizer of the present invention was applied in an amount of 6 kg/plant, the magnesium ammonium phosphate was separately applied in an amount of 6 kg/plant, the polyglutamic acid was separately applied in an amount of 0.5 g/plant, 1.0 g/plant and 1.5 g/plant respectively, and microbial agents of Bacillus subtilis, Trichoderma harzianum and a mixture of Bacillus subtilis and Trichoderma harzianum were separately applied in an amount of 6 kg/plant (the effective viable count was greater than 2 billion/gram). Except fertilization, other field management was consistent. The growth of citrus was observed, and the yield, quality and disease of citrus were determined.

TABLE 6
Effect of the composite fertilizer prepared by the embodiments of the present invention on citrus growth and yield increase

| | | | | Fruit | | Sugar | Soluble | Converted | |
|---|---|---|---|---|---|---|---|---|---|
| | | | Sprout | diameter | | content | solids | yield | Occurrence |
| Embodiment | Leaf color | Treevigor | heading | (mm) | Fruit skin | (%) | (%) | (kg/mu) | of root rot |
| Embodiment 26 | Thickening of | Strong | A large | 78.1 | Thin | 14.6 | 12.7 | 4504.5 | Not |
| | dark green | | amount | | skinwith | | | | occurred |
| | leaves | | | | gloss | | | | |
| Embodiment 27 | Thickening of | Strong | A large | 77.5 | Thin | 14.7 | 12.9 | 4497.2 | Not |
| | dark green | | amount | | skinwith | | | | occurred |
| | leaves | | | | gloss | | | | |
| Embodiment 28 | Thickening of | Strong | A large | 78.2 | Thin | 15.1 | 12.6 | 4471.8 | Not |
| | dark green | | amount | | skinwith | | | | occurred |
| | leaves | | | | gloss | | | | |
| Embodiment 29 | Thickening of | Strong | A large | 77.6 | Thin | 14.8 | 12.8 | 4395.7 | Not |
| | dark green | | amount | | skinwith | | | | occurred |
| | leaves | | | | gloss | | | | |
| Embodiment 30 | Darkgreen | Strong | A large | 76.9 | Thin | 14.5 | 12.5 | 4319.5 | Not |
| | | | amount | | skinwith | | | | occurred |
| | | | | | gloss | | | | |
| Embodiment 31 | Darkgreen | Relatively | Relatively | 75.4 | Thin | 14.3 | 12.4 | 4267.1 | Not |
| | | strong | more | | skinwith | | | | occurred |
| | | | | | gloss | | | | |
| Embodiment 32 | Dark-green | Relatively | Relatively | 74.8 | Thin | 13.8 | 11.9 | 4231.9 | Not |
| | | strong | more | | skinwith | | | | occurred |
| | | | | | low gloss | | | | |
| Magnesium | Green | General | Relatively | 72.3 | Thick | 12.9 | 11.6 | 3815.8 | Sporadically |
| ammonium | | | more | | skinwith | | | | occurred |
| phosphate | | | | | low gloss | | | | |
| Polyglutamic | Lightgreen | General | Less | 68.4 | Thick | 13.2 | 11.4 | 3654.1 | Sporadically |
| acid0.5 g/mu | | | | | skinwith | | | | occurred |
| | | | | | low gloss | | | | |
| 1.0 g/mu of | Lightgreen | General | Less | 69.2 | Thick | 13.5 | 11.7 | 3782.5 | Sporadically |
| polyglutamic | | | | | skinwith | | | | occurred |
| acid | | | | | low gloss | | | | |
| Polyglutamic | Green | Relatively | Relatively | 70.9 | Thin | 13.7 | 11.9 | 3802.4 | Sporadically |
| acid1.5 | | strong | more | | skinwith | | | | occurred |
| g/mu | | | | | low gloss | | | | |
| Bacillus subtilis | Green | General | Less | 67.5 | Thick | 13.1 | 11.2 | 3615.5 | Not |
| | | | | | skinwith | | | | occurred |
| | | | | | low gloss | | | | |
| Trichoderma | Green | General | Less | 66.8 | Thick | 13.3 | 11.4 | 3576.8 | Not |
| harzianum | | | | | skinwith | | | | occurred |
| | | | | | low gloss | | | | |
| Bacillus subtilis + | Green | General | Relatively | 70.3 | Thin | 13.6 | 11.6 | 3758.3 | Not |
| Trichoderma | | | more | | skinwith | | | | occurred |
| harzianum | | | | | gloss | | | | |
| Normal (CK) | Yellowgreen | Weak | Less | 65.4 | Thick | 11.5 | 10.7 | 3586.5 | Severely |
| | | | | | skinwith | | | | occurred |
| | | | | | no gloss | | | | |

As can be seen from the experimental results in Table 6, the co-application of magnesium ammonium phosphate, polyglutamic acid and microbial agent can promote the growth of citrus and increase the yield and quality thereof. According to the present invention, the tree vigor of the citrus tree can be promoted to be strong, the production is high, the leaf color is dark green, the number of sprout heading is increased, the number of high-quality fruits is increased, the color and luster are good, the skin is thin and glossy, the tree vigor of the citrus tree is strong, the number of headed young sprouts is great and the young sprouts are strong, the quality of the citrus can be greatly improved, and meanwhile the occurrence of soil-borne diseases can be reduced.

1. A composite fertilizer, comprising two functional components of polyglutamic acid and magnesium ammonium phosphate.

2. The composite fertilizer according to claim 1, wherein a weight ratio of the polyglutamic acid to the magnesium ammonium phosphate is 1:100 to 10000.

3. The composite fertilizer according to claim 1, further comprising one or more microbial agent components.

4. The composite fertilizer according to claim 3, wherein the microbial agent is selected from the group consisting of Bacillus subtilis, Trichoderma harzianum, rhizobium, Bacillus thuringiensis, and Paecilomyces lilacinus.

5. The composite fertilizer according to claim 3, wherein a total effective viable count of microbial bacteria is greater than 20 million/gram.

6. The composite fertilizer according to claim 3, further comprising an organic matter.

7. The composite fertilizer according to claim 6, wherein a content of the organic matter is greater than 8%.

8. The composite fertilizer according to any claim 1, wherein the fertilizer is a solid composite fertilizer.

9. The composite fertilizer according to claim 1, wherein the composite fertilizer is applied as a base fertilizer or top dressing.

10. A method of increasing yield of crops comprising using a composite fertilizer according to claim 1 to increase the yield of the crops.
